(19) United States
(12) Patent Application Publication
(10) Pub. No.: US 2014/0078125 A1
(43) Pub. Date: Mar. 20, 2014

(54) DRIVE DEVICE FOR LIQUID CRYSTAL DISPLAY DEVICE

(71) Applicant: Kenji GONDO, Yasu-shi (JP)

(72) Inventor: Kenji GONDO, Yasu-shi (JP)

(73) Assignee: Kyocera Display Corporation, Yasu-shi (JP)

(21) Appl. No.: 14/088,153

(22) Filed: Nov. 22, 2013

Related U.S. Application Data
(63) Continuation of application No. PCT/JP2012/062219, filed on May 11, 2012.

(30) Foreign Application Priority Data
May 23, 2011 (JP) 2011-115142

(51) Int. Cl. G09G 3/36

(52) U.S. Cl. CPC G09G 3/3614
USPC 345/209; 345/96

(57) ABSTRACT

A gate driver selects a gate line of an odd-numbered row and a gate line of an even-numbered row subsequent thereto and sets the gate line of the even-numbered row to a selected-period potential with a delay of a predetermined time from a timing when the gate line of the odd-numbered row is set to the selected-period potential. After that, the gate driver sets the potential of the gate line set at the selected-period potential to a nonselected-period potential. A source driver switches polarities of pixels in each column every two rows, and sets potentials of respective source lines to potentials according to image data of respective pixels for one row, while making the polarities of the pixels in adjacent columns opposite to each other.

### TECHNICAL FIELD

The present invention relates to a drive device for liquid crystal display device.

### BACKGROUND ART

In general, a liquid crystal display device of the active matrix system using TFTs (Thin Film Transistors) is constructed with a liquid crystal being interposed between a common electrode and a plurality of pixel electrodes arranged in a matrix pattern. Then, a desired image is displayed by controlling an applied voltage to the liquid crystal between the common electrode and each pixel electrode.

The liquid crystal display device of the active matrix system using TFTs is provided with source lines for respective columns of the pixel electrodes arranged in the matrix pattern and with gate lines for respective rows of the pixel electrodes. A TFT is provided for each pixel electrode. Each individual pixel electrode is connected to a TFT and the TFT is connected to a source line and to a gate line. FIG. 9 is an explanatory drawing showing a connection example of a pixel electrode, a TFT, a source line, and a gate line. FIG. 9 illustrates the pixel electrode connected to the gate line Gᵢ of the i-th row and the source line Sₖ of the k-th column, out of the plurality of pixel electrodes arranged in the matrix pattern. The pixel electrode 21 is connected to a TFT 22 and the TFT 22 is connected to the gate line Gᵢ and to the source line Sₖ. Specifically, the pixel electrode 21 is connected to the drain 22_{b} of the TFT 22. Furthermore, the gate 22ₐ of the TFT 22 is connected to the gate line Gᵢ and the source 22_{c} of the TFT 22 is connected to the source line Sₖ. FIG. 9 shows one pixel electrode, and connection forms of the TFT, gate line and source line in the other pixel electrodes are also the same.

Each gate line is selected in a line-sequential manner, a selected gate line is set at a selected-period potential, and the nonselected gate lines are set at a nonselected-period potential. When a certain gate line is selected, the source lines are set at respective potentials according to image data for a row of the selected gate line. In the TFT 22 arranged for each pixel electrode, when the gate 22ₐ turns to the selected-period potential, the drain 22_{b} and the source 22_{c} become electrically conductive; when the gate 22ₐ turns to the nonselected-period potential, the drain 22_{b} and the source 22_{c} become electrically nonconductive. Therefore, the pixel electrodes in the selected row are set at their respective potentials according to the image data for the row. A potential of the common electrode 30 (see FIG. 9) opposed to each pixel electrode through the liquid crystal (not shown) is also controlled to a predetermined potential. As a consequence of this, voltages according to the image data for the row are applied to the liquid crystal in the selected row. By sequentially selecting the gate lines, an image according to the image data can be displayed. The potential of the common electrode will be denoted below by V_{COM}.

In some parts of the description hereinafter, a value of the selected-period potential will be denoted by VGH and a value of the nonselected-period potential by VGL.

A state in which the potential of a pixel electrode is higher than the potential of the common electrode will be referred to as positive polarity. Moreover, a state in which the potential of a pixel electrode is lower than the potential of the common electrode will be referred to as negative polarity.

As an example of modes for switching the positive and negative polarities, there is a mode of switching the polarities every two rows in each column, while making the polarities different from each other between adjacent columns. This mode will be referred to hereinafter as two-line dot inversion drive. FIG. 10 shows an example of the polarities of respective pixels in the two-line dot inversion drive. In the description hereinafter, the first column is defined as the leftmost column when viewed from the viewer side of the liquid crystal display device and the columns are counted from the left. In the drawings including FIG. 10 and others, “+” indicates the positive polarity and “−” the negative polarity. In the two-line dot inversion drive, when attention is focused on each individual row in a certain frame, as shown in FIG. 10, the polarities of the pixels are different between adjacent columns. For example, with focus on the first row, the pixels in the first row have different polarities between adjacent pixels. In this manner, while the polarities are made different between adjacent pixels in each individual row, the polarities of the pixels in each column are switched every two rows. As a result, for example, in the first column, the pixels in the first row and the second row have the positive polarity and the pixels in the third row and the fourth row have the negative polarity. Furthermore, for example, in the second column, the pixels in the first row and the second row have the negative polarity and the pixels in the third row and the fourth row have the positive polarity.

FIG. 11 is a timing chart showing an example of the potential changes in gate lines and a source line in the two-line dot inversion drive. In FIG. 11, G₁ to G₄ refer to the gate lines of the respective rows from the first row to the fourth row. Furthermore, S₁ refers to the source line of the first column. As shown in FIG. 11, each of the gate lines is selected starting from the gate line G₁ and the gate line selected is set at the selected-period potential VGH. Latch pulses (which will be referred to hereinafter as LP) shown in FIG. 11 are a pulse signal to define start timing of potential setting for the source lines. At a falling edge of LP, each source line is set to a potential according to each pixel in the selected row.

As shown in FIG. 11, the source line S₁ is set to potentials higher than the common electrode potential V_{COM} during selected periods of the gate lines of the first row and the second row, and is set to potentials lower than the common electrode potential V_{COM} during selected periods of the gate lines of the third row and the fourth row. Thereafter, the source line is alternately switched between potentials higher than V_{COM} and potentials lower than V_{COM} every two rows in the same manner. The same also applies to the source lines of the other odd-numbered columns. Each of the source lines of the even-numbered columns, which are omitted from the illustration in FIG. 11, is set to potentials lower than V_{COM} during selected periods of the first row and the second row and is set to potentials higher than V_{COM} during selected periods of the third row and the fourth row. Thereafter, the source line is alternately switched between potentials lower than V_{COM} and potentials higher than V_{COM} every two rows in the same manner. This example shows a case where with LP at a high level, each source line is kept in a high impedance state.

As the potentials of the respective gate lines and the respective source lines are set as described above, the polarities of the respective pixels become as illustrated in FIG. 10. In the next frame, the liquid crystal display device is driven so as to invert the polarities of the respective pixels.

There is another mode for switching the polarities every row in each column, while making the polarities different between adjacent columns. This mode will be referred to hereinafter as one-line dot inversion drive. FIG. 12 shows an example of polarities of respective pixels in the one-line dot inversion drive. In the one-line dot inversion drive, as shown in FIG. 12, the polarities are different between adjacent pixels in each of directions of the columns and rows.

Concerning the one-line dot inversion drive, there is a known drive method of, prior to a selected period of a gate line of a certain row, setting a potential of the gate line to the selected-period potential VGH in advance. This drive method is also called a double gate method. In the double gate method, for example, the potentials of the gate lines of the first row and the third row are simultaneously set to the selected-period potential VGH in the selected period of the first row, and the potentials of the gate lines of the third row and the fifth row are simultaneously set to the selected-period potential VGH in the selected period of the third row. In this case, the gate line of the third row, together with the first row, is set to the selected-period potential VGH during the selected period of the first row, prior to a start of the selected period of the gate line of the third row itself. The same also applies to the rows other than the third row. In this manner, prior to a selected period of the gate line of a certain row, the potential of the gate line is set to the selected-period potential VGH in advance, whereby the pixels in that row can be subjected to precharge, which can reduce power consumption.

FIG. 13 is a timing chart showing an example of the potential changes in gate lines and a source line in the case where the double gate method is adopted in the one-line dot inversion drive. As show in FIG. 13, in the selected period of the gate line G₁ of the first row, not only the gate line G₁ but also the gate line G₃ are set to the selected-period potential VGH. In the selected period of the gate line G₁, duration during which the gate lines G₁ and G₃ are set at the selected-period potential VGH are identical. Thereafter, in the selected period of the gate line Gₙ of the n-th row, not only the gate line Gₙ but also the gate line Gₙ₊₂ are set to the selected-period potential VGH in the same manner. In the selected period of the gate line Gₙ, duration during which the gate lines Gₙ and Gₙ₊₂ are set at the selected-period potential VGH are identical.

As shown in FIG. 13, the source line S₁ is set to a potential higher than the common electrode potential V_{COM} during the selected period of the gate line G₁ of the first row and is set to a potential lower than the common electrode potential V_{COM} during the selected period of the gate line G₂ of the second row. Thereafter, the source line is alternately switched between a potential higher than V_{COM} and a potential lower than V_{COM} every row in the same manner. The same also applies to the source lines of the other odd-numbered columns. Each of the source lines of the even-numbered columns, which are omitted from the illustration in FIG. 13, is set to a potential lower than the common electrode potential V_{COM} during the selected period of the gate line G₁ and is set to a potential higher than the common electrode potential V_{COM} during the selected period of the gate line G₂. Thereafter, the source line is alternately switched between a potential lower than V_{COM} and a potential higher than V_{COM} every row in the same manner. With LP at the high level, each source line is kept in a high impedance state.

As the potentials of the respective gate lines and the respective source lines are set in this manner, the polarities of the respective pixels become as shown in FIG. 12. The double gate method can reduce power consumption when compared to the simple line-sequential drive.

The double gate method is described, for example, in Patent Documents 1, 2 and others. Patent Document 1 discloses that a preliminary on-signal is set at least two lines prior to a regular on-signal. The pulse duration of the regular on-signal is the same as the pulse duration of the preliminary on-signal.

Patent Document 2 discloses that when H represents the selected period of each gate line, the gate line of the N-th row is again set to the selected-period potential with a lapse of 4H since a time of a start of the selected period of the gate line of the N-th row. Duration during which the gate line of the N-th row is again set at the selected-period potential is also H. Furthermore, Patent Document 2 discloses that the potentials of the source lines are switched between potentials in the positive polarity and potentials in the negative polarity every 2H, to realize the switching of polarities as exemplified in FIG. 10.

Patent Document 3 discloses that a gate drive waveform is kept continuous for at least two clocks.

### PRIOR ART DOCUMENTS

### Patent Documents

Patent Document 1: JP-A-4-67122 (Page 3, FIG. 1)
Patent Document 2: JP-A-2001-249643 (Paragraphs 0016-0024, FIG. 4)
Patent Document 3: JP-A-2001-195043 (Page 1)

### DISCLOSURE OF INVENTION

### Technical Problem

In the two-line dot inversion drive, it is preferable to make power consumption as low as possible.

In the one-line dot inversion drive, it is also preferable to make power consumption as low as possible.

It is therefore an object of the present invention to provide a drive device for liquid crystal display device that can realize the two-line dot inversion drive with less power consumption. It is another object to provide a drive device for liquid crystal display device that can realize the one-line dot inversion drive with less power consumption.

### Solution to Problem

A drive device for liquid crystal display device according to a first aspect of the present invention is a drive device for liquid crystal display device, which drives a liquid crystal display device including source lines arranged along columns of pixels formed in a matrix pattern and gate lines arranged along rows of the pixels formed in the matrix pattern, the drive device for liquid crystal display device comprising: a gate driver (e.g., gate driver 3) which selects a gate line of an odd-numbered row and a gate line of an even-numbered row subsequent thereto, which sets the gate line of the even-numbered row at a selected-period potential with a delay of a first predetermined time (e.g., t) from timing when the gate line of the odd-numbered row is set at the selected-period potential (e.g., VGH), and which thereafter sets the gate line of the odd-numbered row at a nonselected-period potential (e.g., VGL); and a source driver (e.g., source driver 4 in the first embodiment) which switches polarities of the pixels in each column every two rows and which sets potentials of the respective source lines to potentials according to image data of respective pixels for one row, while making the polarities of the pixels in adjacent columns opposite to each other.

The drive device for liquid crystal display device according to the first aspect of the present invention may be configured as follows: it comprises: control means (e.g., timing controller 2) which feeds to the gate driver, a switching signal (e.g., CKV in the first embodiment) to indicate switching of gate lines to be selected, an output enable signal for an odd-numbered row to indicate a duration during which the gate line of the odd-numbered row selected is kept at the selected-period potential, and an output enable signal for an even-numbered row to indicate duration during which the gate line of the even-numbered row selected is kept at the selected-period potential, and which feeds to the source driver, a source line potential setting indication signal (e.g., LP) to indicate that the potentials of the respective source lines are to be set to potentials according to image data of the respective pixels for one row, and a polarity control signal (e.g., POL₂ in the first embodiment) to make the polarities of the pixels in each column switched every two rows; the control means operates as follows: the control means feeds a signal changed to a first level (e.g., a high level) and a second level (e.g., a low level) in a predetermined period, as the switching signal to the gate driver; the control means raises the source line potential setting indication signal at timing when the switching signal is changed to the first level, and defines a period of the source line potential setting indication signal as half of the period of the switching signal; the control means feeds to the gate driver, the output enable signal for odd-numbered row (e.g., OE_{odd}) to indicate as the duration during which the gate line of the odd-numbered row is kept at the selected-period potential, a duration of H-s from a change of a level of the switching signal to the first level when 2H represents the period of the switching signal, t represents the first predetermined time, and s represents a second predetermined time, and the output enable signal for an even-numbered row (e.g., OEₑᵥₑₙ) to indicate as the duration during which the gate line of the even-numbered row is kept at the selected-period potential, duration from a point of time when t has elapsed since the change of the level of the switching signal to the first level, to a point of time when 2H-s has elapsed since the change of the level of the switching signal to the first level; the gate driver operates as follows: the gate driver selects a gate line of an odd-numbered row and a gate line of an even-numbered row subsequent thereto, every switching of the switching signal to the first level, and sets the selected gate line of the odd-numbered row to the selected-period potential in accordance with the output enable signal for an odd-numbered row and the selected gate line of the even-numbered row to the selected-period potential in accordance with the output enable signal for an even-numbered row; and the source driver sets the potentials of the respective source lines to potentials according to image data of respective pixels for one row in synchronism with a falling edge of the source line potential setting indication signal.

In the drive device for liquid crystal display device according to the first aspect of the present invention, the first predetermined time is preferably a time that is at least the sum of a time needed to change the potentials of the source lines from a minimum to a maximum of set potentials for the source lines, and a time needed to change the source line potential setting indication signal to a high level.

A drive device for liquid crystal display device according to a second aspect of the present invention is a drive device for liquid crystal display device, which drives a liquid crystal display device including source lines arranged along columns of pixels formed in a matrix pattern and gate lines arranged along rows of the pixels formed in the matrix pattern, the drive device for liquid crystal display device comprising: a gate driver (e.g., gate driver 3ₐ) which selects a gate line; and a source driver (e.g., source driver 4 in the second embodiment) which switches polarities of the pixels in each column every row and which sets potentials of the respective source lines to potentials according to image data of respective pixels for one row, while making the polarities of the pixels in adjacent columns opposite to each other, wherein the gate driver selects one gate line, and a subsequent gate line that is a gate line of a row after the next to the one gate line, sets the subsequent gate line to a selected-period potential with a delay of a first predetermined time (e.g., t) from timing when the one gate line is set at the selected-period potential (e.g., VGH), and sets the one gate line and the subsequent gate line to a nonselected-period potential (e.g., VGL), prior to selection of the gate line next to the one gate line.

The drive device for liquid crystal display device according to the second aspect of the present invention may be configured as follows: it comprises: control means (e.g., timing controller 2ₐ) which feeds to the gate driver, a switching signal (e.g., CKV in the second embodiment) to indicate switching of a gate line to be selected, and an output enable signal for each row to, when a gate line is selected by the gate driver, indicate duration during which the gate line is kept at the selected-period potential, and which feeds to the source driver, a source line potential setting indication signal (e.g., LP) to indicate that potentials of the respective source lines are to be set to potentials according to image data of respective pixels for one row, and a polarity control signal (e.g., POL₂ in the second embodiment) to make the polarities of the pixels in each column switched every row; the control means operates as follows: the control means feeds a signal changed to a first level and a second level in a predetermined period, as the switching signal to the gate driver; the control means raises the source line potential setting indication signal at timing when the switching signal is changed to the first level, defines a period of the source line potential setting indication signal to be the same period as the period of the switching signal, and feeds to the gate driver, the output enable signal to indicate as the duration during which the one gate line selected by the gate driver is kept at the selected-period potential, duration of H-s from a change of a level of the switching signal to the first level when H represents the period of the switching signal, t represents the first predetermined time, and s represents a second predetermined time, and the output enable signal to indicate as the duration during which the subsequent gate line to the one gate line is kept at the selected-period potential, duration from a point of time when t has elapsed since the change of the level of the switching signal to the first level, to a point of time when H-s has elapsed since the change of the level to the switching signal to the first level; the gate driver operates as follows: the gate driver switches the one gate line and the subsequent gate line selected, every switching of the switching signal to the first level, and sets the selected gate line and subsequent gate line to the selected-period potential in accordance with the output enable signal; and the source driver sets the potentials of the respective source lines to potentials according to image data of respective pixels for one row in synchronism with a falling edge of the source line potential setting indication signal.

In the drive device for liquid crystal display device according to the second aspect of the present invention, the first predetermined time is preferably a time that is at least the sum of a time needed to change the potentials of the source lines from a minimum to a maximum of set potentials for the source lines, and a time needed to change the source line potential setting indication signal to a high level.

### Advantageous Effects of Invention

The present invention enables achievement of the two-line dot inversion drive with less power consumption. The present invention also enables achievement of the one-line dot inversion drive with less power consumption.

### BRIEF DESCRIPTION OF DRAWINGS

FIG. 1 is an explanatory drawing showing a configuration example of the drive device for liquid crystal display device according to a first embodiment of the present invention.

FIG. 2 is an explanatory drawing showing changes of POL₁ and POL₂ in the embodiment of the present invention.

FIG. 3 is a timing chart showing input timing of each of STH and CLK to a source driver 4 in the beginning of a frame in the embodiment of the present invention.

FIG. 4 is a timing chart showing STV and CKV input to a gate driver, an operation of the gate driver 3, and others in the embodiment of the present invention.

FIG. 5 is a timing chart showing potential changes in pixel electrodes and others in the embodiment of the present invention.

FIG. 6 is an explanatory drawing showing a method of determining a predetermined duration in the embodiment of the present invention.

FIG. 7 is an explanatory drawing showing a configuration example of the drive device for liquid crystal display device according to a second embodiment of the invention.

FIG. 8 is a timing chart showing an example of operation according to the second embodiment of the present invention.

FIG. 9 is an explanatory drawing showing a connection example of a pixel electrode, a TFT, a source line, and a gate line in the embodiment of the present invention.

FIG. 10 is a schematic drawing showing an example of polarities of respective pixels in the two-line dot inversion drive.

FIG. 11 is a timing chart showing an example of potential changes in gate lines and a source line in the line dot inversion drive

FIG. 12 is a schematic drawing showing an example of polarities of respective pixels in the one-line dot inversion drive.

FIG. 13 is a timing chart showing an example of potential changes in gate lines and a source line in a case where the double gate method is adopted in the one-line dot inversion drive.

### DESCRIPTION OF EMBODIMENTS

Embodiments of the present invention will be described below with reference to the drawings.

### Embodiment 1

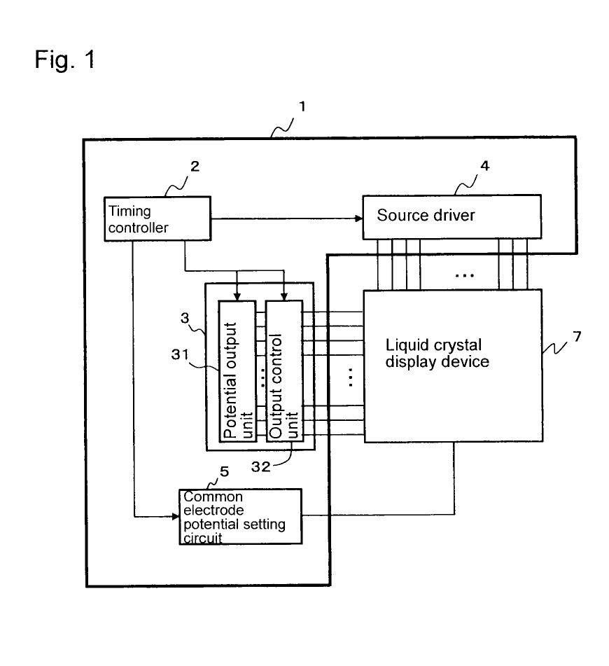

FIG. 1 is an explanatory drawing showing a configuration example of the drive device for liquid crystal display device according to a first embodiment of the present invention. The drive device 1 of the present embodiment drives a liquid crystal display device 7 of the active matrix system using TFTs.

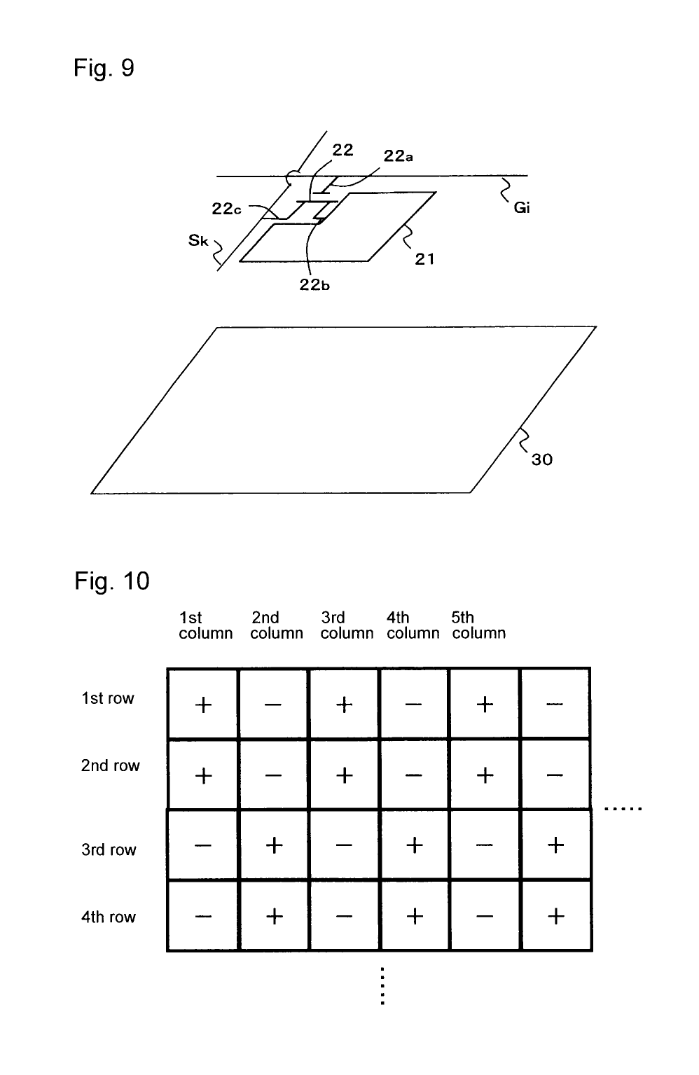

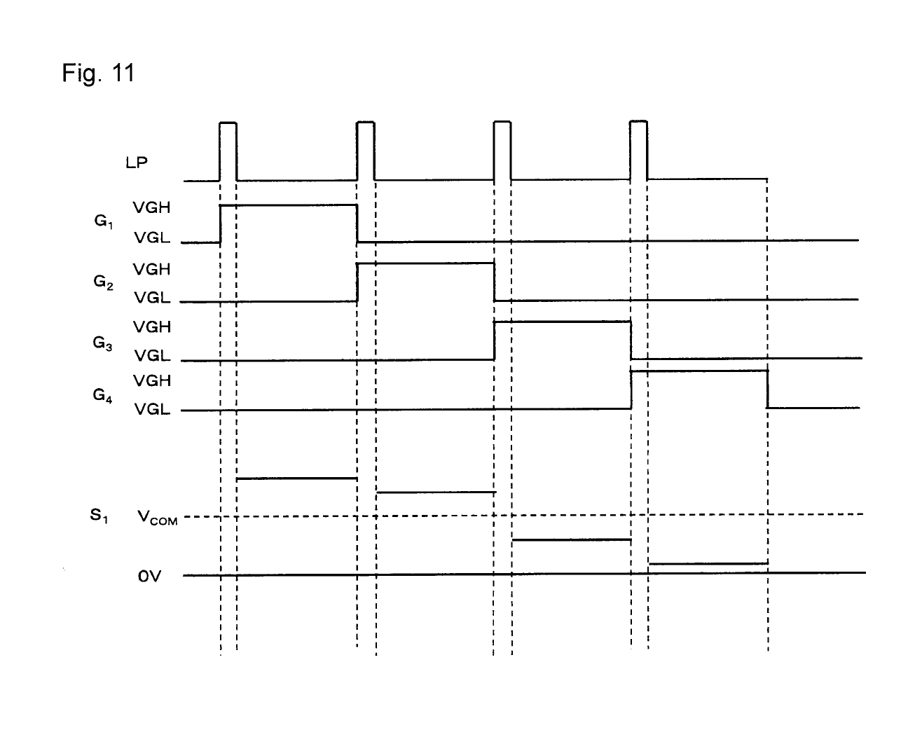

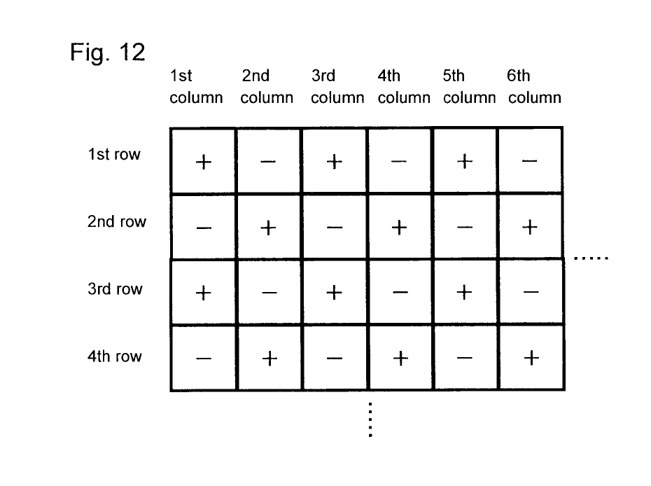

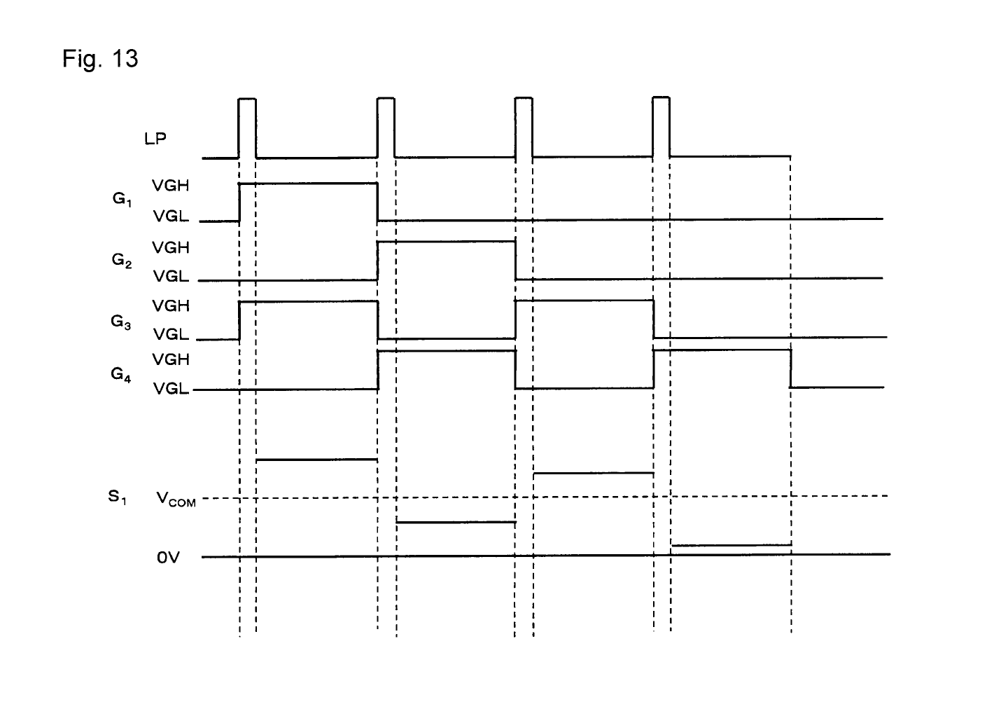

The liquid crystal display device 7, as exemplified in FIG. 9, is provided with a common electrode 30 and pixel electrodes 21 arranged for respective pixels. FIG. 9 shows one pixel electrode, but the liquid crystal display device 7 is provided with a plurality of pixel electrodes 21 arranged in a matrix pattern. Furthermore, the liquid crystal display device 7 is provided with a plurality of source lines arranged along columns of the plurality of pixel electrodes 21 arranged in the matrix pattern and a plurality of gate lines arranged along rows of the plurality of pixel electrodes 21. An example will be described herein using a case where the source lines are arranged for the respective columns of the pixel electrodes and where the gate lines are arranged for the respective rows of the pixel electrodes. Namely, the example to be explained is a case where the source lines and the respective columns are in one-to-one correspondence and where the gate lines and the respective rows are in one-to-one correspondence.

The liquid crystal display device 7 is also provided with a TFT 22 for each individual pixel electrode, as exemplified in FIG. 9. Therefore, combinations, each of which includes a TFT 22 and a pixel electrode 21, are arranged in the matrix pattern. Then, the gate 22ₐ of each individual TFT 21 is connected to a gate line corresponding to a row in which the TFT is arranged. The drain 22_{b} of each individual TFT 21 is connected to a pixel electrode corresponding to the TFT. The source 22_{c} of each individual TFT 21 is connected to a source line corresponding to a column in which the TFT is arranged.

The drive device 1 is provided with a timing controller 2, a gate driver 3, a source driver 4, and a common electrode potential setting circuit 5. It is noted that an illustration of a power generating circuit for liquid crystal is omitted.

The common electrode potential setting circuit 5 sets a potential of the common electrode of the liquid crystal display device 7 to a predetermined potential V_{COM}.

The gate driver 3 operates in accordance with the timing controller 2 to perform scanning of the gate lines while selecting each gate line, to set the potential of a selected gate line to a selected-period potential VGH and to set the potential of nonselected gate lines to a nonselected-period potential VGL. A period during which the potential of the gate line is set at the selected-period potential VGH will be referred to as a selected-period potential set period.

After a lapse of a predetermined time since a start of the selected-period potential set period for a gate line of an odd-numbered row, the gate driver 3 starts the selected-period potential set period for a gate line of an even-numbered row immediately subsequent to the foregoing row. This predetermined time will be represented by t. The time t is shorter than the selected-period potential set period for the gate line of the odd-numbered row. Therefore, before an end of the selected-period potential set period for the gate line of the odd-numbered row, the selected-period potential set period for the gate line of the subsequent row is started, and thus the selected-period potential set periods for the odd-numbered row and the subsequent row overlap in part.

The gate driver 3 ends the selected-period potential set period for the gate line of the even-numbered row and then starts the selected-period potential set period for a gate line of an odd-numbered row immediately subsequent to the foregoing row. Therefore, there is no overlap of the selected-period potential set periods between the even-numbered row and the subsequent row.

The gate driver 3 includes a potential output unit 31 and an output control unit 32.

The potential output unit 31 has potential output terminals corresponding to the respective gate lines. When k represents an integer of at least 1, a set is defined as a couple of two potential output terminals corresponding to a (2k−1)-th gate line and a (2k)-th gate line and the selected-period potential VGH is sequentially output from each set of two potential output terminals. The nonselected-period potential VGL is output from the potential output terminals other than those outputting the selected-period potential VGH. That the potential output unit 31 outputs VGH from a set of two potential output terminals means that the gate driver 3 selects the gate lines corresponding to the two potential output terminals (the gate line of the odd-numbered row and the gate line of the subsequent even-numbered row). The timing controller 2 feeds a control signal (gate start pulses, which will be represented by STV) to indicate sequential selection of the gate lines, to the potential output unit 31. In the present embodiment, STV is used to instruct the potential output unit 31 to sequentially output the selected-period potential VGH starting from the first set of potential output terminals (i.e., a set of potential output terminals corresponding to the gate lines of the first row and the second row). The potential output unit 31 outputs the selected-period potential VGH for each set of potential output terminals, sequentially from the first set of potential output terminals, according to STV and below-described CKV. The timing controller 2 feeds a control signal (gate shift clocks, which will be represented by CKV) to indicate switching of selected gate lines, to the potential output unit 31. In the present embodiment, CKV is used to instruct the potential output unit 31 to switch the set of potential output terminals to output the selected-period potential VGH, to the next set. The potential output unit 31 switches the set of potential output terminals to output the selected-period potential VGH, to the next set, according to CKV input from the timing controller 2.

The output control unit 32 has potential input terminals and potential output terminals corresponding to the respective gate lines. The potentials output from the potential output unit 31 are input to the respective potential input terminals of the output control unit 32. Therefore, the selected-period potential VGH from the potential output unit 31 is sequentially input to each set of odd-numbered and subsequent even-numbered potential input terminals, starting from the set of potential input terminals corresponding to the gate lines of the first row and the second row. The nonselected-period potential VGL from the potential output unit 31 is input to the potential input terminals to which the selected-period potential VGH is not input.

The potential output terminals of the output control unit 32 are connected to the corresponding gate lines, respectively. The output control unit 32 outputs the selected-period potential VGH, according to output enable signals input from the timing controller 2, from the potential output terminals (potential output terminals of the output control unit 32) corresponding to two potential input terminals to which the selected-period potential VGH is input from the potential output unit 31. The output control unit 32 receives the output enable signal to define a potential output from the odd-numbered ((2k−1)-th) potential output terminal from the first (which will be denoted by OE_{odd}) and the output enable signal to define a potential output from the even-numbered (2k-th) potential output terminal from the first (which will be denoted by OEₑᵥₑₙ), out of the two potential output terminals corresponding to the two potential input terminals to which the selected-period potential VGH is input. With OE_{odd} being at a high level, the output control unit 32 outputs VGH from the odd-numbered potential output terminal from the first, out of the two potential output terminals corresponding to the two potential input terminals to which the selected-period potential VGH is input. Similarly, with OEₑᵥₑₙ being at a high level, it outputs VGH from the even-numbered potential output terminal from the first, out of the two potential output terminals corresponding to the two potential input terminals to which the selected-period potential VGH is input. For example, let us assume that the selected-period potential VGH is input from the potential output unit 31 to the first and second potential input terminals. Then, the output control unit 32 outputs the selected-period potential VGH from the first potential output terminal for duration during which OE_{odd} is at the high level. It also outputs the selected-period potential VGH from the second potential output terminal for duration during which OEₑᵥₑₙ is at the high level.

The output control unit 32 outputs the nonselected-period potential VGL from the potential output terminals other than the potential output terminals outputting the selected-period potential VGH. Since the potential output terminals of the output control unit 32 are connected to the respective corresponding gate lines, each gate line is set at the output potential of the corresponding potential output terminal of the output control unit 32.

The potential output terminal of the potential output unit 31 corresponding to an arbitrary n-th gate line will be denoted by Oₙ′. The potential output terminal of the output control unit 32 corresponding to an arbitrary n-th gate line will be denoted by Oₙ.

The source driver 4 has potential output terminals corresponding to the respective source lines. The source driver 4 reads image data in accordance with control of the timing controller 2. Then the source driver 4 sets potentials of the respective source lines connected to the respective potential output terminals, to potentials according to image data of pixels in a row corresponding to a selected gate line. Specifically, the timing controller 2 feeds to the source driver 4, a control signal to indicate a start of read of image data for one row (source start pulse, which will be denoted by STH), a clock signal to indicate read of image data of one pixel in one row (dot clock, which will be denoted by CLK), and LP (latch pulse) to indicate output of potentials according to already-read image data. The periods of STH and LP are half of the period of CKV and, when detecting a falling edge of LP, the source driver 4 sets the potentials of the respective source lines of the liquid crystal display device 7 to potentials according to the read image data. It is, however, noted that an example described below is a case where the source driver 4 keeps each potential output terminal in a high impedance state, for duration during which LP is at a high level.

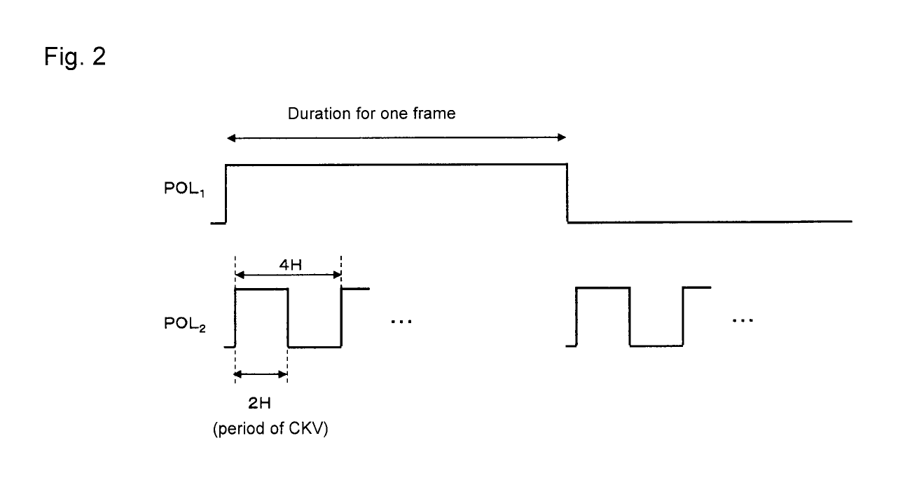

The timing controller 2 feeds to the source driver 4, two types of control signals (which will be denoted by POL₁ and POL₂) for defining polarities of the respective pixels. FIG. 2 is an explanatory drawing showing changes in POL₁ and POL₂. The timing controller 2 alternately switches POL₁ between a high level and a low level, frame by frame (see FIG. 2). The timing controller 2 also changes POL₂ in the period of twice the period of CKV. In the first embodiment, the period of CKV will be defined below as 2H. Therefore, the period of POL₂ is 4H. Then the timing controller 2 alternately switches the level of POL₂ between a high level and a low level at intervals of 2H. The timing controller 2 changes POL₂ so that POL₂ turns to the high level at the first falling edge of LP in a frame.

When POL₁ and POL₂ both are at the high level, the source driver 4 sets the odd-numbered source lines to potentials higher than the common electrode potential V_{COM} and sets the even-numbered source lines to potentials lower than the common electrode potential V_{COM}.

When POL₁ is at the high level and POL₂ is at the low level, the source driver 4 sets the odd-numbered source lines to potentials lower than the common electrode potential V_{COM} and sets the even-numbered source lines to potentials higher than the common electrode potential V_{COM}.

When POL₁ is at the low level and POL₂ is at the high level, the source driver 4 sets the odd-numbered source lines to potentials lower than the common electrode potential V_{COM} and sets the even-numbered source lines to potentials higher than the common electrode potential V_{COM}.

When POL₁ and POL₂ both are at the low level, the source driver 4 sets the odd-numbered source lines to potentials higher than the common electrode potential V_{COM} and sets the even-numbered source lines to potentials lower than the common electrode potential V_{COM}.

2H is twice the period of LP. Therefore, in each frame, the polarities of the pixels in each column are switched every two rows. Since the polarities in the odd-numbered columns are always different from those in the even-numbered columns, the two-line dot inversion drive is carried out in the present embodiment. For duration during which POL₁ is at the high level, the polarities of the respective pixels are the same as those of the respective pixels shown in FIG. 10. For duration during which POL₁ is at the low level, the polarities of the respective pixels are opposite to those of the respective pixels shown in FIG. 10.

The timing controller 2 feeds STV and CKV to the potential output unit 31 of the gate driver 3 and feeds OE_{odd} and OEₑᵥₑₙ to the output control unit 32 of the gate driver 3. Furthermore, the timing controller 2 feeds STH, CLK, LP, POL₁, and POL₂ to the source driver 4. Concerning POL₁ and POL₂, the timing controller 2 may feed only POL to the source driver 4. Namely, the timing controller 2 may feed one signal (denoted by POL) as a signal for controlling the polarities, to the source driver 4. In this case, the timing controller 2 can be configured to feed a signal indicative of Exclusive OR (XOR) of POL₁ and POL₂ described above, as POL to the source driver 4.

An operation will be described below.

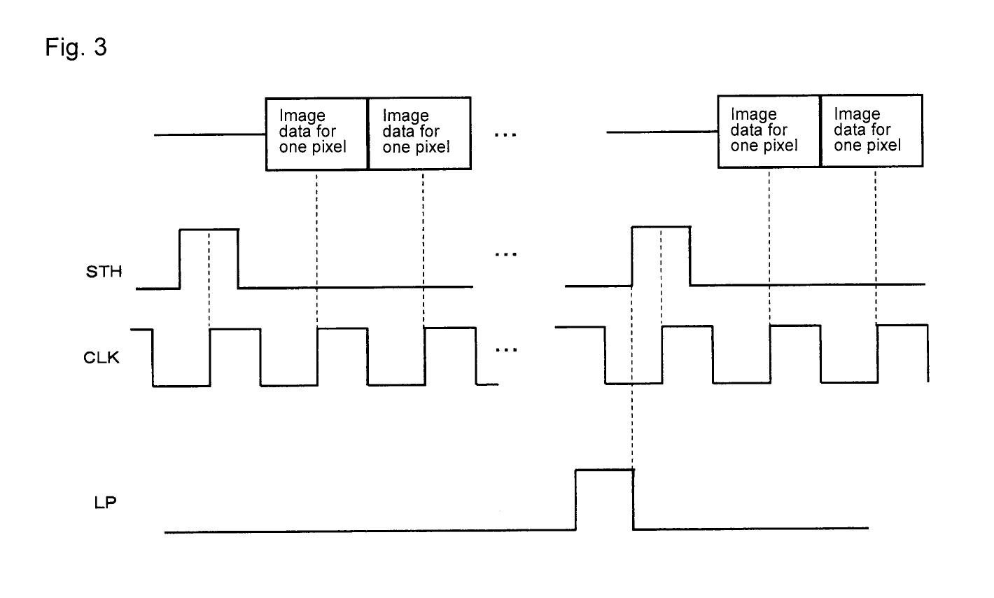

FIG. 3 is a timing chart showing input timing of each of STH and CLK to the source driver 4 in the beginning of a frame. In the beginning of the frame, the timing controller 2 changes STH to the high level. At this time, the timing controller 2 keeps LP at the low level and also keeps each of the signals STV, CKV, OE_{odd}, and OEₑᵥₑₙ (not shown in FIG. 3) to be input to the gate driver 3, at the low level.

The timing controller 2 alternately changes CLK between the high level and the low level on a periodic basis. However, it changes CLK so as to place a rising edge of CLK in duration during which STH is at the high level. The timing controller 2 turns STH to the high level, then turns CLK to the high level in duration of STH at the high level, and turns STH to the low level. When detecting a rising edge of CLK in the duration of STH at the high level, the source driver 4 reads and retains image data for one pixel at every detection of a rising edge of CLK, starting from the next rising edge of CLK (see FIG. 3).

The timing controller 2 raises STH to the high level in the period of half of CKV (not shown in FIG. 3). Then the timing controller 2 feeds the image data for one row to the source driver 4 in each duration from a falling edge to a rising edge of STH. In the beginning of a frame, the timing controller 2 feeds the image data of the first row to the source driver 4. The source driver 4 reads and retains the image data input from the timing controller 2, pixel by pixel, at every rising edge of CLK.

When first turning CKV to the high level in the frame, the timing controller 2 changes LP to the high level and then changes LP back to the low level. Thereafter, the timing controller 2 raises LP to the high level in the period of half of CKV. Moreover, the timing controller 2 matches the timing of each rising edge of LP with a level switching timing of CKV. When detecting a falling edge of LP, the source driver 4 sets potentials of the respective source lines of the liquid crystal display device 7, to potentials according to the retained image data of the respective pixels in one row.

Therefore, in one frame, as shown in FIG. 3, the source driver 4 reads and retains the image data of the first row in duration from the first rising edge of STH to the falling edge of STH, and sets the potentials of the respective source lines to potentials according to the image data of the respective pixels in the first row, at the first falling edge of LP in the frame. An example to be described below is a case where POL₁ is at the high level and the polarities of the respective pixels are set as shown in FIG. 10.

Thereafter, in the same manner as above, the source driver 4 periodically repeats the operation of reading the image data for one row and setting the potentials of the respective source lines to potentials according to the image data, in accordance with STH, CLK, and LP.

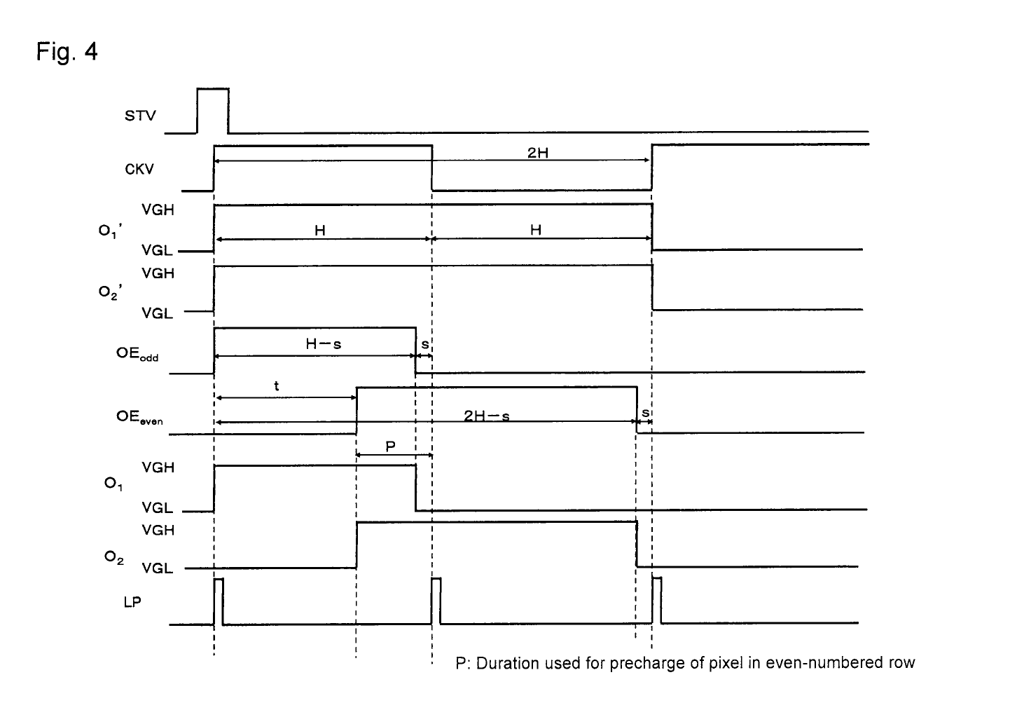

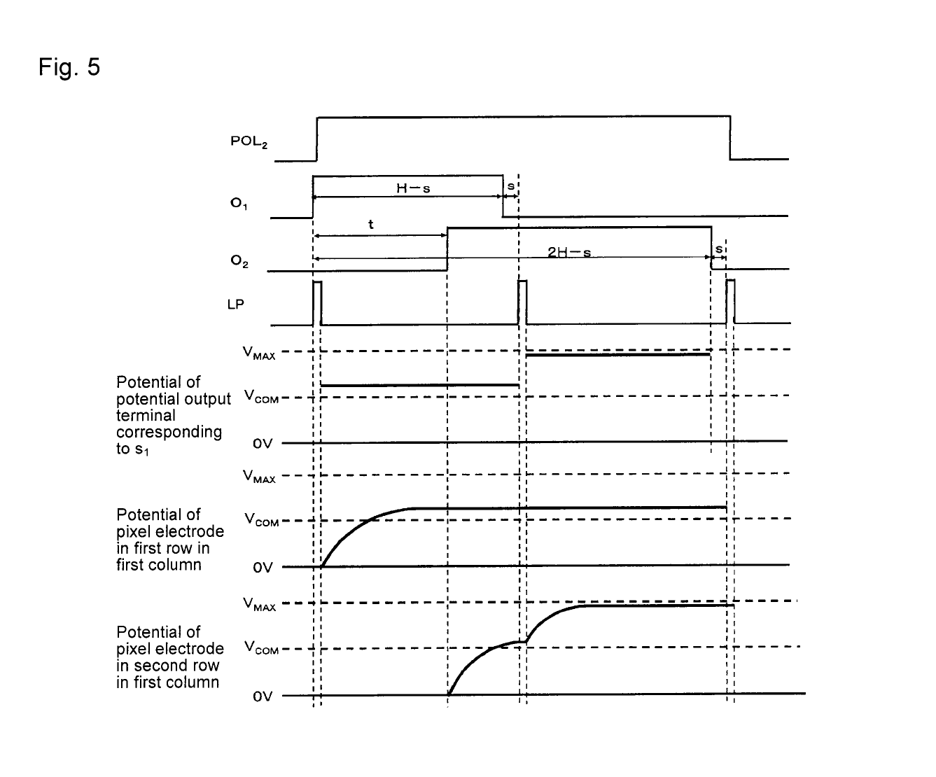

FIG. 4 is a timing chart showing STV and CKV input to the gate driver, the operation of the gate driver 3, and others. FIG. 5 is a timing chart showing changes in potentials of the pixel electrodes and others.

The timing controller 2 changes STV to the high level at a start of sequential selection from the gate line of the first row, changes CKV to the high level in duration of STV at the high level, and thereafter changes STV to the low level (see FIG. 4). The timing controller 2 turns LP to be input to the source driver 4, to the high level in synchronism with this rising edge of CKV (see FIG. 4). It is, however, noted that the controller may turn LP to the high level with a delay of several ten to several hundred pulses of CLK, without synchronism with the rising edge of CKV.

The period of CKV is 2H; when duration H has elapsed since the rising edge of CKV, the timing controller 2 changes CKV to the low level; when another duration H has elapsed, it again changes CKV to the high level. Thereafter, the timing controller 2 changes CKV in the same manner.

When detecting the rising edge of CKV in the duration of STV at the high level, the potential output unit 31 (see FIG. 1) of the gate driver 3 outputs the selected-period potential VGH from the potential output terminals O₁′, O₂′ corresponding to the gate lines of the first row and the second row (see FIG. 4) and outputs the nonselected-period potential VGL from each of the other potential output terminals. Thereafter, the potential output unit 31 switches the set of potential output terminals outputting the selected-period potential VGH, at every rising edge of CKV (in other words, in the period of 2H), to output the selected-period potential VGH from the potential output terminal O₂ₖ₋₁′ corresponding to an odd-numbered row and the potential output terminal O₂ₖ′ corresponding to an even-numbered row. Furthermore, it outputs the nonselected-period potential VGL from each of the other potential output terminals.

The timing controller 2 raises OE_{odd} to the high level at the same timing as the rising edge of CKV. Furthermore, it raises OEₑᵥₑₙ to the high level when a predetermined time t has elapsed since the rising edge of OE_{odd}. It changes OE_{odd} to the low level when duration H-s has elapsed since the rising edge of OE_{odd}. Then it turns OEₑᵥₑₙ to the low level when duration 2H-s has elapsed since the rising edge of OE_{odd}. The timing controller 2 changes OE_{odd} and OEₑᵥₑₙ in this manner at every rise of CKV to the high level. The lengths of the times t and s are determined in advance.

The output control unit 32 outputs the selected-period potential VGH from the potential output terminal O₁ corresponding to the gate line of the first row for duration during which the selected-period potential VGH is input from the potential output terminals O₁′, O₂′ of the electron output unit 31 and during which OE_{odd} is at the high level, to set the potential of the gate line G₁ of the first row to VGH. Namely, the output control unit 32 sets the potential of the gate line G₁ at VGH for the duration of H-s from the rising edge of OE_{odd} (see FIG. 4).

The output control unit 32 outputs the selected-period potential VGH from the potential output terminal O₂ corresponding to the gate line of the second row for a duration during which the selected-period potential VGH is input from the potential output terminals O₁′, O₂′ of the electron output unit 31 and during which OEₑᵥₑₙ is at the high level, to set the potential of the gate line G₂ of the second row to VGH. Namely, the output control unit 32 sets the potential of the gate line G₂ at VGH for the duration from a point of time when the predetermined time t has elapsed since the rising edge of OE_{odd} to a point of time when 2H-s has elapsed since the rising edge of OE_{odd} (see FIG. 4).

When detecting the first falling edge of LP after the start of the frame, the source driver 4 sets the potentials of the respective source lines to the potentials according to the respective pixels in the first row. FIG. 5 shows potentials of the potential output terminal of the source driver 4 corresponding to the first source line S₁ from the left, and potential changes in the pixel electrodes in the first row and the second row in the first column from the left.

At the first falling edge of LP after the frame start, POL₂ is at the high level. It is assumed that in this frame POL₁ is also at the high level. Therefore, when detecting the first falling edge of LP after the frame start, the source driver 4 sets the potentials of the odd-numbered source lines from the left, such as the source line S₁, to potentials higher than V_{COM} (see FIG. 5). The source driver 4 also sets the potentials of the even-numbered source lines from the left to potentials lower than V_{COM}.

Describing an example of the pixel electrodes in the first row and the second row in the first column from the left, these two pixel electrodes are set at a potential (0 V in the example shown in FIG. 5) lower than V_{COM} in the preceding frame. It is assumed in this example that 0 V<V_{COM}<Vₘₐₓ, that 0 V is a potential corresponding to the maximum gray level in the negative polarity, and that Vₘₐₓ is a potential corresponding to the maximum gray level in the positive polarity. Furthermore, Vₘₐₓ−V_{COM}=V_{COM}−0. When the source driver 4 sets the potential of the source line S₁ to a potential higher than V_{COM}, since the output control unit 32 has set the gate line G₁ of the first row to the selected-period potential VGH, the pixel electrode in the first row in the first column from the left is changed to the potential equal to that of the source line S₁ (see FIG. 5). Then, it becomes equipotential to the source line S₁ before the predetermined time t has elapsed from the rising edge of OE_{odd}. When H-s has elapsed since the rising edge of OE_{odd}, the potential of the gate line G₁ is switched to the nonselected-period potential VGL; however, the pixel electrode in the first row in the first column maintains the potential at that point.

Furthermore, when the predetermined time t has elapsed since the output of the selected-period potential VGH from the potential output terminal O₁, the output control unit 32 outputs the selected-period potential VGH from the potential output terminal O₂ to set the potential of the gate line G₂ in the second row to VGH. As a consequence of this, the pixel electrode in the second row in the first column from the left also changes so as to approach the potential of the source line S₁ (see FIG. 5). However, since each source line is changed into the high impedance state with a change of LP to the high level, the potential change stops.

When detecting the next falling edge of LP, the source driver 4 sets the potentials of the respective source lines to potentials according to the image data of the respective pixels in the second row. Since at this time POL₂ is also at the high level, the source driver 4 sets the potentials of the odd-numbered source lines from the left, such as the source line S₁, to potentials higher than V_{COM} (see FIG. 5). The source driver 4 also sets the potentials of the even-numbered source lines from the left to potentials lower than V_{COM}.

At this time, the output control unit 32 is outputting the selected-period potential VGH from the potential output terminal O₂ and the potential of the gate line G₂ of the second row is VGH. Therefore, the pixel electrode in the second row in the first column from the left varies to the potential of the source line S₂, so as to become equipotential to the source line S₂.

In this frame, the pixel electrodes in the first row and in the second row in the first column from the left are set both to the potentials in the positive polarity (i.e., the potentials higher than V_{COM}). Furthermore, the pixel electrode in the second row in the first column from the left starts changing toward the potential higher than V_{COM}, prior to the second falling edge of LP after the frame start. This means that the pixel in the second row in the first column from the left is subjected to precharge. This example described the example of the first column from the left but the precharge is also performed in the same manner for the pixel in the second row in each of the other odd-numbered columns from the left. In each of the even-numbered columns from the left, the pixel electrode in the second row is set at a potential lower than V_{COM} and starts changing toward the potential lower than V_{COM}, prior to the second falling edge of LP after the frame start. This means that the precharge is also performed for the pixel in the second row in each of the even-numbered columns.

Thereafter, the operation of the gate driver 3 (the potential output unit 31 and the output control unit 32) with change of CKV to the high level is the same as the above operation, except for switching of the gate lines to be set at the selected-period potential VGH. Therefore, the precharge is also performed for the pixels in the even-numbered rows, out of the pixels in each of the third and subsequent rows.

Since the present embodiment involves execution of the precharge for each pixel in the even-numbered rows in this manner, it can reduce power consumption.

In the present embodiment, the duration P (see FIG. 4) from the point of time when the predetermined time t has elapsed from the rising edge of OE_{odd} to the next rising edge of LP is set to be the duration of execution of the precharge. Therefore, the entire selected-period potential set period of the odd-numbered gate line is not used as the duration of execution of the precharge, which enhances the effect of a reduction in power consumption.

Namely, the present embodiment can realize the two-line dot inversion drive with less power consumption.

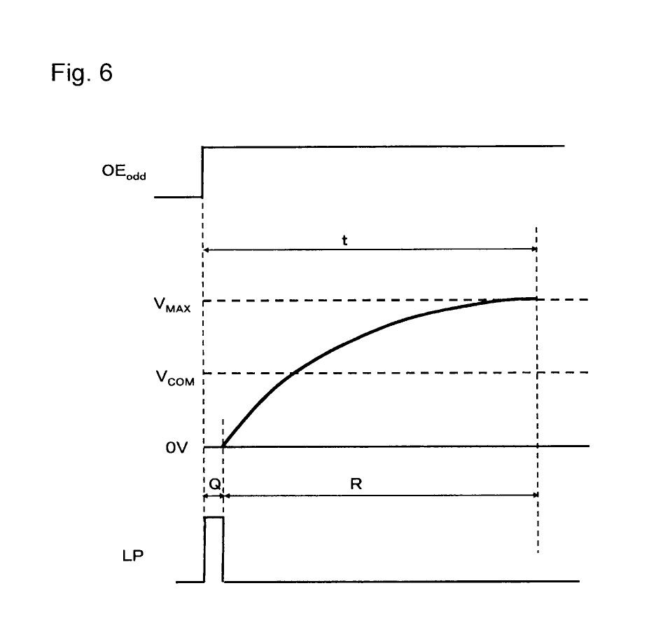

How to determine the predetermined duration t will be described below. FIG. 6 is an explanatory drawing showing a method of determining the predetermined duration t. A time needed to change a potential of a source line from the minimum to the maximum of set potentials for the source lines is defined as R. A time needed to change a potential of a source line from the maximum to the minimum of set potentials for the source lines is also R. The minimum of the set potentials for the source lines is the potential corresponding to the maximum gray level in the negative polarity and, in the present example, it is 0 V. The maximum of the set potentials for the source lines is the potential corresponding to the maximum gray level in the positive polarity and, in the present example, it is V_{MAX}. In the present example, therefore, R may be determined to be a time necessary for a change of the potential of the source line from 0 V to V_{MAX}. The predetermined time t may be determined to be at least a value obtained by adding a duration Q of LP at the high level to R. Namely, t can be determined to satisfy t≧Q+R. LP is changed to the high level in synchronism with the rising edge of OE_{odd} and from the falling edge of LP, the source lines are set to potentials according to image data. Therefore, when t is determined to satisfy t≧Q+R, the potential of each source line can be changed from any potential in the negative polarity to any desired potential in the positive polarity within the predetermined time t. Likewise, the potential of each source line can be changed from any potential in the positive polarity to any desired potential in the negative polarity within the predetermined time t.

### Embodiment 2

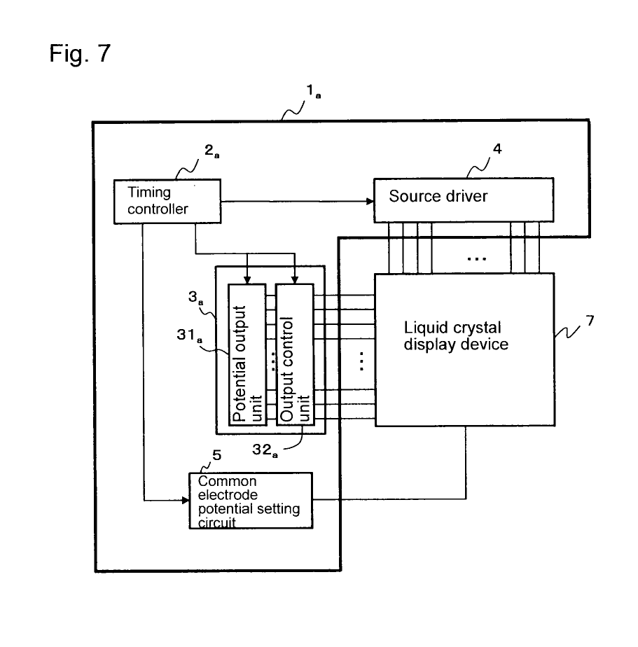

In a second embodiment of the present invention, explanation will be made of a drive device that realizes the one-line dot inversion drive. FIG. 7 is an explanatory drawing showing a configuration example of the drive device for liquid crystal display device according to the second embodiment of the present invention. The same elements as those in the first embodiment will be denoted by the same reference signs as in FIG. 1, while omitting the description thereof.

The liquid crystal display device 7 is the same as the liquid crystal display device 7 described in the first embodiment.

The drive device 1ₐ according to the present embodiment is provided with a timing controller 2ₐ, a gate driver 3ₐ, a source driver 4, and a common electrode potential setting circuit 5.

The timing controller 2ₐ feeds STH, CLK, LP, POL₁, and POL₂ to the source driver 4. In the present embodiment, however, the periods of STH, LP, and POL₂ are the same as the period of CKV input from the timing controller 2ₐ to the gate driver 3ₐ. In the second embodiment, the periods of CKV, STH, LP, and POL₂ will be defined below as H. The operation of the source driver 4 in accordance with STH, CLK, LP, POL₁, and POL₂ is the same as in the first embodiment. Concerning POL₁ and POL₂, the timing controller 2ₐ may feed only POL to the source driver 4. Namely, the timing controller 2ₐ may feed one signal (POL) as a signal for controlling the polarities, to the source driver 4. In this case, the timing controller 2ₐ can feed a signal indicative of Exclusive OR (XOR) of POL₁ and POL₂ described above, as POL to the source driver 4.

When selecting a gate line of an odd-numbered row, the gate driver 3ₐ also selects a gate line of the next odd-numbered row. However, the gate driver 3ₐ first sets the first gate line to the selected-period potential VGH, out of the two gate lines, and when the predetermined time t has elapsed, the gate driver 3ₐ sets the second gate line to the selected-period potential VGH. Then, after completion of selection of the gate lines of the two odd-numbered rows, the gate driver 3ₐ selects gate lines of even-numbered rows. The predetermined time t may be determined in the same manner as in the first embodiment.

Similarly, when selecting a gate line of an even-numbered row, the gate driver 3ₐ also selects a gate line of the next even-numbered row. However, the gate driver 3ₐ first sets the first gate line to the selected-period potential VGH, out of the two gate lines, and when the predetermined time t has elapsed, the gate driver 3ₐ sets the second gate line to the selected-period potential VGH. After completion of selection of the gate lines of the two even-numbered rows, the gate driver 3ₐ selects gate lines of odd-numbered rows.

In the second embodiment, therefore, there is an overlap of the selected-period potential set periods between gate lines of odd-numbered rows or between gate lines of even-numbered rows, but there is no overlap of the selected-period potential set periods between odd-numbered and even-numbered rows.

The gate driver 3ₐ has a potential output unit 31ₐ and an output control unit 32ₐ. The potential output unit 31ₐ has potential output terminals corresponding to the respective gate lines. Furthermore, the output control unit 32ₐ has potential input terminals and potential output terminals corresponding to the respective gate lines. The potentials output from the corresponding potential output terminals of the potential output unit 31ₐ are input to the potential input terminals of the output control unit 32ₐ. As in the first embodiment, the potential output terminals of the potential output unit 31ₐ will be denoted by Oₙ′, and the potential output terminals of the output control unit 32ₐ will be denoted by Oₙ.

When detecting a rising edge of CKV in a duration during which STV input from the timing controller 2ₐ is at the high level, the potential output unit 31ₐ outputs the selected-period potential VGH from the first potential output terminal. Then the potential output unit 31ₐ shifts the potential output terminal to output the selected-period potential VGH, by one at every detection of a rising edge of CKV. As described below, the timing controller 2ₐ turns STV to the high level twice in the beginning of a frame. Time duration between the two rising edges of STV is twice the period (H) of CKV. Therefore, the potential output unit 31ₐ starts the operation of outputting the selected-period potential VGH in order from the first potential output terminal, and thereafter, in synchronism with the operation, it again outputs the selected-period potential VGH in order from the first potential output terminal. Therefore, the potential output unit 31ₐ outputs the selected-period potential VGH from two potential output terminals and sequentially shifts the potential output terminals to output VGH. Specifically, the potential output unit 31ₐ outputs VGH from the potential output terminals O₁′, O₃′, then outputs VGH from the potential output terminals O₂′, O₄′, and thereafter sequentially shifts the potential output terminals to output VGH, in the same manner.

The potential output unit 31ₐ outputs the nonselected-period potential VGL from the potential output terminals not to output VGH.

The output control unit 32ₐ outputs the selected-period potential VGH in accordance with an output enable signal input from the timing controller 2ₐ, starting from the potential output terminals (potential output terminals of the output control unit 32ₐ) corresponding to two potential input terminals to which the selected-period potential VGH is input from the potential output unit 31ₐ. In the present embodiment, the timing controller 2ₐ feeds to the output control unit 32ₐ, the output enable signal corresponding to each potential output terminal of the output control unit 32ₐ. The output enable signal corresponding to the n-th potential output terminal will be denoted by OEₙ.

When VGH from the potential output unit 31ₐ is input to two odd-numbered potential input terminals, the output control unit 32ₐ outputs VGH for duration during which the output enable signal corresponding to each potential output terminal is at the high level, from two potential output terminals corresponding to the two potential input terminals. For example, in a case where VGH is input from the potential output unit 31ₐ to the (2j+1)-th and (2j+3)-th potential input terminals, VGH is output for duration of OE₂ⱼ₊₁ at the high level from the (2j+1)-th potential output terminal. VGH is output for duration of OE₂ⱼ₊₃ at the high level from the (2j+3)-th potential output terminal. It is noted that j is an integer of at least 0.

When VGH from the potential output unit 31ₐ is input to two even-numbered potential input terminals, the output control unit 32ₐ outputs VGH for duration during which the output enable signal corresponding to each potential output terminal is at the high level, from two potential output terminals corresponding to the two potential input terminals. For example, in a case where VGH is input from the potential output unit 31ₐ to the (2j+2)-th and (2j+4)-th potential input terminals, VGH is output for duration of OE₂ⱼ₊₂ at the high level from the (2j+2)-th potential output terminal. VGH is output for a duration of OE₂ⱼ₊₄ at the high level from the (2j+4)-th potential output terminal.

The timing controller 2ₐ feeds STV and CKV to the potential output unit 31ₐ. In the second embodiment, as described above, the period of CKV is set to H. In the beginning of a frame, STV is changed to the high level and then back to the low level, and thereafter, when 2H has elapsed since a rising edge thereof, STV is again changed to the high level and back to the low level. Then it controls CKV so that one rising edge of CKV appears in duration during which STV is at the high level.

The timing controller 2ₐ feeds each output enable signal to the output control unit 32ₐ. The output enable signal OEₙ corresponding to the n-th potential output terminal is controlled as follows. Namely, the timing controller 2ₐ changes OEₙ to the high level at a point of time when the predetermined time t has elapsed since the rising edge of CKV to output VGH from the (n−2)-th potential output part in the potential output unit 31ₐ, and changes OEₙ to the low level at a point of time when H-s has elapsed since the rising edge of CKV. Furthermore, it changes OEₙ to the high level at the rising edge of CKV to output VGH from the (n)-th potential output part in the potential output unit 31ₐ, and changes OEₙ to the low level at a point of time when H-s has elapsed since the rising edge of CKV. The length of the time s may be determined in advance.

However, concerning OE₁ corresponding to the first potential output terminal, OE₁ may be controlled to be changed to the high level at the rising edge of CKV to output VGH from the first potential output part in the potential output unit 31ₐ and then to the low level at a point of time when H-s has elapsed since the rising edge of CKV. Concerning OE₂ corresponding to the second potential output terminal, OE₂ may be controlled to be changed to the high level at the rising edge of CKV to output VGH from the second potential output part in the potential output unit 31ₐ and then to the low level at a point of time when H-s has elapsed since the rising edge of CKV.

The timing controller 2ₐ feeds STH, CLK, LP, POL₁, and POL₂ to the source driver 4. As described previously, the periods of STH, LP, and POL₂ are the same as the period H of CKV.

Next, an operation will be described.

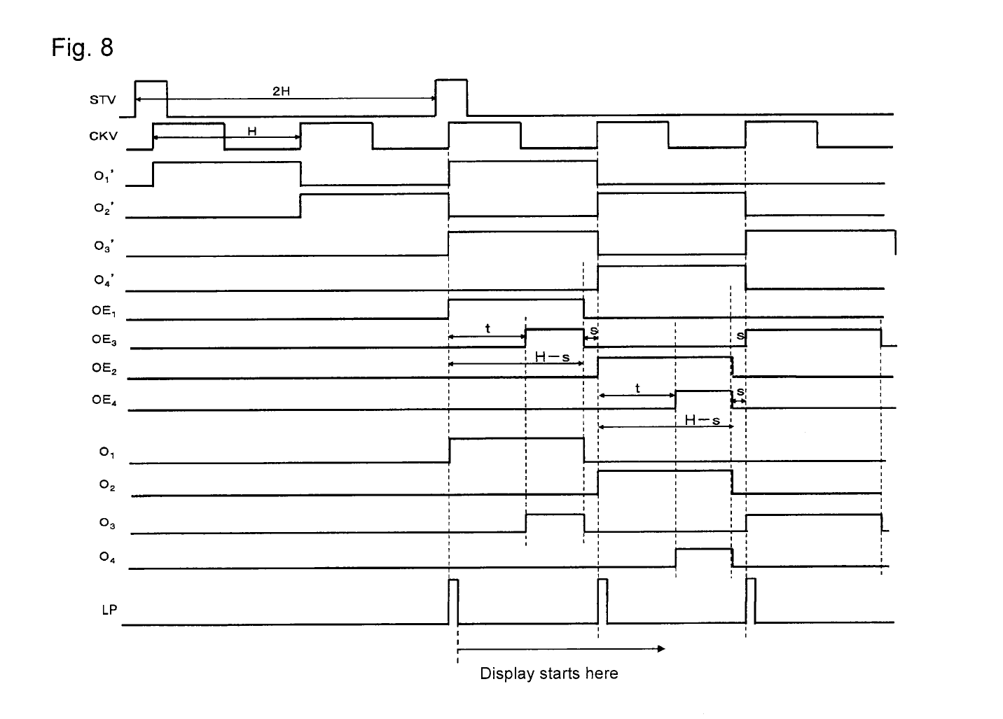

FIG. 8 is a timing chart showing an example of operation in the second embodiment. The timing controller 2ₐ changes STV to the high level in the beginning of a frame, changes CKV to the high level in duration of STV at the high level, and then changes STV back to the low level. The timing controller 2ₐ alternately switches the level of CKV between the high level and the low level at every lapse of a time of H/2 (see FIG. 8). As a consequence of this, the period of CKV becomes H. At this time, the timing controller 2ₐ maintains each OEₙ at the low level.

When detecting a rising edge of CKV in duration of STV at the high level, the potential output unit 31ₐ outputs the selected-period potential VGH from the first potential output terminal O₁′ and thereafter, switches the potential output terminal to output VGH, at every detection of a rising edge of CKV.

At this time, since each output enable signal is at the low level, the output potential of each potential output terminal of the output control unit 32ₐ is VGL.

When 2H (twice the period of CKV) has elapsed since the first rising edge of STV in the frame, the timing controller 2ₐ again changes STV to the high level and then back to the low level. At this time, the timing controller 2ₐ also changes CKV to the high level in the duration of STV at the high level (see FIG. 8). Therefore, the potential output unit 31ₐ again detects a rising edge of CKV in the duration of STV at the high level. For this reason, the potential output unit 31ₐ outputs the selected-period potential VGH from the first potential output terminal O₁′ and thereafter switches the potential output terminal to output VGH, at every detection of a rising edge of CKV. Namely, the potential output unit 31ₐ outputs the potential VGH from the potential output terminals O₁′ and O₃′ and, when detecting a rising edge of CKV, it outputs the potential VGH from the potential output terminals O₂′ and O₄′. Furthermore, when detecting a rising edge of CKV, it outputs the potential VGH from the potential output terminals O₃′ and O₅′. In this manner, the potential output unit 31ₐ sequentially switches the potential output terminals to output VGH.

The timing controller 2ₐ changes OE₁ corresponding to the first potential output terminal O₁ of the output control unit 32ₐ to the high level in synchronism with a rising edge of CKV in the second duration of STV at the high level. Furthermore, the timing controller 2ₐ changes OE₃ corresponding to the third potential output terminal O₃ of the output control unit 32ₐ when the predetermined time t has elapsed since the rising edge of CKV. Then the timing controller 2ₐ changes OE₁ and OE₂ to the low level when the time H-s has elapsed since the rising edge of CKV.

Therefore, the output control unit 32ₐ outputs VGH from the potential output terminal O₁ to keep the potential of the first-row gate line G₁ at VGH during the time H-s from the rising edge of CKV in the second duration of STV at the high level.

The timing controller 2ₐ changes LP to the high level in synchronism with the rising edge of CKV and then changes LP back to the low level. Up to this point, LP is maintained at the low vel. The timing controller 2ₐ may output STH so that the source driver 4 can complete read of the image data for the first row before the first rising edge of LP. The operation for the source driver 4 to read the image data in synchronism with STH and CLK is the same as in the first embodiment. It is also possible to change LP to the high level with a delay of several ten to several hundred pulses of CLK, without synchronism with the rising edge of CKV.

The source driver 4 sets the potentials of the respective source lines to potentials according to the image data of the respective pixels in the first row, at the first falling edge of LP. At this time, since the potential of the first-row gate line G₁ is VGH, each pixel electrode in the first row changes so as to become equipotential to the source line of the corresponding column.

It is assumed that in this frame POL₁ is at the high level and POL₂ also has been changed to the high level at the first falling edge of LP. Therefore, the source driver 4 sets the odd-numbered source lines to potentials higher than the common electrode potential V_{COM} and sets the even-numbered source lines to potentials lower than the common electrode potential V_{COM}. Accordingly, among the pixel electrodes in the first row, the pixel electrodes in the odd-numbered columns are changed to the potentials higher than V_{COM} and the pixel electrodes in the even-numbered columns are changed to the potentials lower than V_{COM}.

Since each pixel electrode is set at a potential in the opposite polarity to that in the preceding frame, the potential is changed across V_{COM}. Since the predetermined time t is defined as the same as in the first embodiment, each pixel electrode in the first row becomes equipotential to the corresponding source line before the predetermined time t has elapsed from the rising edge of CKV.

As described previously, the timing controller 2ₐ changes OE₃ to the high level at the point of time when the predetermined time t has elapsed since the rising edge of CKV. Then the output control unit 32ₐ also outputs VGH from the potential output terminal O₃ corresponding to the third row, to change the potential of the third-row gate line G₃ to VGH. As a consequence of this, each pixel electrode in the third row also starts changing toward the potential of the corresponding source line. The timing controller 2ₐ changes OE₃ to the low level when the time of H-s has elapsed since the rising edge of CKV, and the output control unit 32ₐ stops the output of VGH from the potential output terminals O₁ and O₃. Therefore, the potential of each pixel electrode in the third row changes up to this point and the change of potential stops at this point.

In the present embodiment, the period of POL₂ is the same as the period of CKV, and in each column, the pixels in the odd-numbered rows have the same polarity and the pixels in the even-numbered rows also have the same polarity. However, the polarity of the pixels in the odd-numbered rows is opposite to that of the pixels in the even-numbered rows in each column.

Therefore, each pixel electrode in the third row changes to a potential in the polarity of each pixel in the third row in the present frame in the duration of OE₃ at the high level. Namely, the pixels in the third row are subjected to precharge.

Subsequently, the potential output unit 31ₐ switches the potential output terminals to output VGH, from O₁′, O₃′ to O₂′, O₄′, at the next rising edge of CKV. The timing controller 2ₐ changes OE₂ corresponding to the second potential output terminal O₂ of the output control unit 32ₐ to the high level, in synchronism with the rising edge of CKV. Furthermore, the timing controller 2ₐ changes OE₄ corresponding to the fourth potential output terminal O₄ of the output control unit 32ₐ to the high level when the predetermined time t has elapsed since the rising edge of CKV. Then the timing controller 2ₐ changes OE₂ and OE₄ to the low level when the time H-s has elapsed since the rising edge of CKV.

The output control unit 32ₐ outputs VGH from the potential output terminal O₂ during the time H-s from the rising edge of CKV, to keep the potential of the second-row gate line G₂ at VGH.

The timing controller 2ₐ changes LP to the high level in synchronism with the rising edge of CKV and then changes LP back to the low level. The source driver 4 sets the potentials of the respective source lines to potentials according to the image data for the pixels in the second row, at the falling edge of LP. Since the potential of the second-row gate line G₂ is VGH, each pixel electrode in the second row changes to become equipotential to the source line of the corresponding column. Since POL₂ is at the low level at this time, the source driver 4 sets the odd-numbered source lines to potentials lower than the common electrode potential V_{COM} and sets the even-numbered source lines to potentials higher than the common electrode potential V_{COM}. Therefore, among the pixel electrodes in the second row, the pixel electrodes in the odd-numbered columns change to the potentials lower than V_{COM} and the pixel electrodes in the even-numbered columns change to the potentials higher than V_{COM}. As in the case of the pixel electrodes in the first row, the pixel electrodes in the second row change across V_{COM} but each pixel electrode in the second row becomes equipotential to the corresponding source line before the predetermined time t has elapsed since the rising edge of CKV.

As described previously, the timing controller 2ₐ changes OE₄ to the low level at the point of time when the predetermined time t has elapsed since the rising edge of CKV. Then the output control unit 32ₐ also outputs VGH from the potential output terminal O₄ corresponding to the fourth row, to change the potential of the fourth-row gate line G₄ to VGH. As a consequence of this, each pixel electrode in the fourth row also starts changing toward the potential of the corresponding source line. The timing controller 2ₐ stops the output of VGH from the potential output terminals O₂ and O₄ when the time of H-s has elapsed since the rising edge of CKV. Therefore, the potential of each pixel electrode in the fourth row changes up to this point and the change of potential stops at this point.

Therefore, each pixel electrode in the fourth row changes to a potential in the polarity of the pixel in the fourth row in the present frame in the duration of OE₄ at the high level. Namely, the pixels in the fourth row are subjected to precharge.

Furthermore, the potential output unit 31ₐ switches the potential output terminals to output VGH, from O₂′, O₄′ to O₃′, O₅′, at the next rising edge of CKV. The timing controller 2ₐ changes OE₃ corresponding to the third potential output terminal O₃ of the output control unit 32ₐ to the high level, in synchronism with the rising edge of CKV. Furthermore, the timing controller 2ₐ changes OE₅ corresponding to the fifth potential output terminal O₅ of the output control unit 32ₐ to the high level when the predetermined time t has elapsed since the rising edge of CKV. Then the timing controller 2ₐ changes OE₃ and OE₅ to the low level when the time H-s has elapsed since the rising edge of CKV.

The output control unit 32ₐ outputs VGH from the potential output terminal O₃ during the time H-s from the rising edge of CKV, to keep the potential of the third-row gate line G₃ at VGH.

The timing controller 2ₐ changes LP to the high level in synchronism with the rising edge of CKV and then changes LP back to the low level. The source driver 4 sets the potentials of the respective source lines to potentials according to the image data for the respective pixels in the third row, at the falling edge of LP. Since the potential of the third-row gate line G₃ is VGH, each pixel electrode in the third row changes to become equipotential to the source line of the corresponding column. Here, each pixel in the third row has been precharged when the source driver 4 outputs the potentials according to the image data for the first row. Therefore, power consumption needed to make each pixel electrode in the third row equipotential to the source line of each column is reduced.

As in the case of the precharge for each pixel electrode in the third row, each pixel electrode in the fifth row is subjected to precharge in the duration of OE₅ at the high level.

The drive device 1ₐ repeats the same operation in this frame thereafter.

In the present embodiment, as described above, when the potential of the gate line Gₙ is changed to VGH by changing OEₙ corresponding to the n-th row to the high level at the rising edge of CKV, OEₙ₊₂ is also changed to the high level to precharge the pixel electrodes in the (n+2)-th row, at the point of time when the time t has elapsed since the rising edge of CKV. Therefore, power consumption can be reduced. In the present embodiment, when OEₙ is changed to the high level, OEₙ₊₂ is set to the high level during a time shorter by t than the duration of OEₙ at the high level, which enhances the effect of a reduction in power consumption.

In this manner, the present embodiment can realize the one-line dot inversion drive with less power consumption.

The liquid crystal display device 7 driven by the drive device in each of the foregoing embodiments may be a liquid crystal display device of the in-plane switching drive system. The liquid crystal display device of the in-plane switching drive system is also provided with the source lines for respective columns and the gate lines for respective rows.

### INDUSTRIAL APPLICABILITY

The present invention is suitably applied, for example, to driving of TFT liquid crystal display devices and others.

This application is a continuation of PCT Application No. PCT/JP2012/062219, filed on May 11, 2012, which is based upon and claims the benefit of priority from Japanese Patent Application 2011-115142 filed on May 23, 2011. The contents of those applications are incorporated herein by reference in its entirety.

What is claimed is:

1. A drive device for liquid crystal display device, which drives a liquid crystal display device including source lines arranged along columns of pixels formed in a matrix pattern and gate lines arranged along rows of the pixels formed in the matrix pattern, the drive device for liquid crystal display device comprising:
a gate driver which selects a gate line of an odd-numbered row and a gate line of an even-numbered row subsequent thereto, which sets the gate line of the even-numbered row at a selected-period potential with a delay of a first predetermined time from timing when the gate line of the odd-numbered row is set at the selected-period potential, and which thereafter sets the gate line of the odd-numbered row at a nonselected-period potential; and
a source driver which switches polarities of the pixels in each column every two rows and which sets potentials of the respective source lines to potentials according to image data of respective pixels for one row, while making the polarities of the pixels in adjacent columns opposite to each other.

2. The drive device for liquid crystal display device according to claim 1, comprising:
control means which feeds to the gate driver, a switching signal to indicate switching of gate lines to be selected, an output enable signal for an odd-numbered row to indicate duration during which the gate line of the odd-numbered row selected is kept at the selected-period potential, and an output enable signal for an even-numbered row to indicate duration during which the gate line of the even-numbered row selected is kept at the selected-period potential, and which feeds to the source driver, a source line potential setting indication signal to indicate that potentials of the respective source lines are to be set to potentials according to image data of respective pixels for one row, and a polarity control signal to make the polarities of the pixels in each column switched every two rows,
wherein the control means operates as follows:
the control means feeds a signal changed to a first level and a second level in a predetermined period, as the switching signal to the gate driver;
the control means raises the source line potential setting indication signal at timing when the switching signal is changed to the first level, and defines a period of the source line potential setting indication signal as half of the period of the switching signal;
the control means feeds to the gate driver, the output enable signal for an odd-numbered row to indicate as the duration during which the gate line of the odd-numbered row is kept at the selected-period potential, duration of H-s from a change of a level of the switching signal to the first level when 2H represents the period of the switching signal, t represents the first predetermined time, and s represents a second predetermined time, and the output enable signal for an even-numbered row to indicate as the duration during which the gate line of the even-numbered row is kept at the selected-period potential, duration from a point of time when t has elapsed since the change of the level of the switching signal to the first level, to a point of time when 2H-s has elapsed since the change of the level of the switching signal to the first level,
wherein the gate driver operates as follows:
the gate driver selects a gate line of an odd-numbered row and a gate line of an even-numbered row subsequent thereto, every switching of the switching signal to the first level, and sets the selected gate line of the odd-numbered row to the selected-period potential in accordance with the output enable signal for an odd-numbered row and the selected gate line of the even-numbered row to the selected-period potential in accordance with the output enable signal for an even-numbered row, and
wherein the source driver sets the potentials of the respective source lines to potentials according to image data of respective pixels for one row in synchronism with a falling edge of the source line potential setting indication signal.

3. The drive device for liquid crystal display device according to claim 2,
wherein the first predetermined time is a time that is at least the sum of a time needed to change the potentials of the source lines from a minimum to a maximum of set potentials for the source lines, and a time needed to change the source line potential setting indication signal to a high level.

4. A drive device for liquid crystal display device, which drives a liquid crystal display device including source lines arranged along columns of pixels formed in a matrix pattern and gate lines arranged along rows of the pixels formed in the matrix pattern, the drive device for liquid crystal display device comprising:
a gate driver which selects a gate line; and
a source driver which switches polarities of the pixels in each column every row and which sets potentials of the respective source lines to potentials according to image data of respective pixels for one row, while making the polarities of the pixels in adjacent columns opposite to each other,
wherein the gate driver selects one gate line, and a subsequent gate line that is a gate line of a row after the next to the one gate line, sets the subsequent gate line to a selected-period potential with a delay of a first predetermined time from timing when the one gate line is set at the selected-period potential, and sets the one gate line and the subsequent gate line to a nonselected-period potential, prior to selection of the gate line next to the one gate line.

5. The drive device for liquid crystal display device according to claim 4, comprising:
control means which feeds to the gate driver, a switching signal to indicate switching of a gate line to be selected, and an output enable signal for each row to, when a gate line is selected by the gate driver, indicate duration during which the gate line is kept at the selected-period potential, and which feeds to the source driver, a source line potential setting indication signal to indicate that potentials of the respective source lines are to be set to potentials according to image data of respective pixels for one row, and a polarity control signal to make the polarities of the pixels in each column switched every row,
wherein the control means operates as follows:
the control means feeds a signal changed to a first level and a second level in a predetermined period, as the switching signal to the gate driver;
the control means raises the source line potential setting indication signal at timing when the switching signal is changed to the first level, defines a period of the source line potential setting indication signal to be the same as the period of the switching signal, and feeds to the gate driver, the output enable signal to indicate as the duration during which the one gate line selected by the gate driver is kept at the selected-period potential, duration of H-s from a change of a level of the switching signal to the first level when H represents the period of the switching signal, t represents the first predetermined time, and s represents a second predetermined time, and the output enable signal to indicate as the duration during which the subsequent gate line to the one gate line is kept at the selected-period potential, duration from a point of time when t has elapsed since the change of the level of the switching signal to the first level, to a point of time when H-s has elapsed since the change of the level of the switching signal to the first level,
wherein the gate driver operates as follows:
the gate driver switches the one gate line and the subsequent gate line selected, every switching of the switching signal to the first level, and sets the selected gate line and subsequent gate line to the selected-period potential in accordance with the output enable signal, and
wherein the source driver sets the potentials of the respective source lines to potentials according to image data of respective pixels for one row in synchronism with a falling edge of the source line potential setting indication signal.

6. The drive device for liquid crystal display device according to claim 5,
wherein the first predetermined time is a time that is at least the sum of a time needed to change the potentials of the source lines from a minimum to a maximum of set potentials for the source lines, and a time needed to change the source line potential setting indication signal to a high level.
